(19) United States
(12) Patent Application Publication
(10) Pub. No.: US 2019/0195025 A1
(43) Pub. Date: Jun. 27, 2019

(54) APPARATUS AND METHOD

(71) Applicant: GE Oil & Gas UK Limited, Nailsea (GB)

(72) Inventors: Zhimin Tan, Katy, TX (US); Yucheng Hou, Katy, TX (US); Jiabei Yuan, Houston, TX (US); Linfa Zhu, Houston, TX (US)

(73) Assignee: GE Oil & Gas UK Limited, Nailsea (GB)

(21) Appl. No.: 15/853,443

(22) Filed: Dec. 22, 2017

(51) Int. Cl. E21B 17/01; E21B 17/20; F16L 1/24; F16L 11/133

(52) U.S. Cl. CPC E21B 17/012; E21B 17/015; F16L 11/133; F16L 1/24; E21B 17/20

(57) ABSTRACT

A buoyancy compensating assembly and method of deploying a riser assembly are disclosed. The buoyancy compensating assembly for connection to a portion of flexible pipe, comprises at least one rigid buoyancy module for connection to a riser; and at least one regulating element configured to control the pressure within the at least one rigid buoyancy module in use.

### FIELD

The present invention relates to an apparatus and method. In particular, but not exclusively, the present invention relates to an apparatus and method for providing flexible pipes having rigid buoyancy modules for helping hold the pipe in the water in a preferred position, for example when extracting oil and gas from a seabed location.

### BACKGROUND AND SUMMARY

Traditionally flexible pipe is utilised to transport production fluids, such as oil and/or gas and/or water, from one location to another. Flexible pipe is particularly useful in connecting a sub-sea location (which may be deep underwater) to a sea level location. The pipe may have an internal diameter of typically up to around 0.6 metres (e.g. diameters may range from 0.05 m up to 0.6 m). Flexible pipe is generally formed as an assembly of a flexible pipe body and one or more end fittings. The pipe body is typically formed as a combination of layered materials that form a pressure-containing conduit. The pipe structure allows large deflections without causing bending stresses that impair the pipe's functionality over its lifetime. The pipe body is generally built up as a combined structure including polymer, and/or metallic, and/or composite layers. For example, a pipe body may include polymer and metal layers, or polymer and composite layers, or polymer, metal and composite layers.

During use, the flexible pipe may be positioned to connect the subsea location to the sea level location and lay in that configuration for many years.

API Recommended Practice 17B provides guidelines for the design, analysis, manufacture, testing installation, and operation of flexible pipes and flexible pipe systems for onshore, subsea and marine applications.

API Specification 17J titled “Specification for Unbonded Flexible Pipe” defines the technical requirements for safe, dimensionally and functionally interchangeable flexible pipes that are designed and manufactured to uniform standards and criteria.

Unbonded flexible pipe has been used for deep water (less than 3,300 feet (1,005.84 metres)) and ultra-deep water (greater than 3,300 feet) developments. It is the increasing demand for oil which is causing exploration to occur at greater and greater depths where environmental factors are more extreme. Increased depths increase the pressure associated with the environment in which the flexible pipe must operate. For example, a flexible pipe may be required to operate with external pressures ranging from 0.1 MPa to 30 MPa acting on the pipe. Equally, transporting oil, gas or water may well give rise to high pressures acting on the flexible pipe from within, for example with internal pressures ranging from zero to 140 MPa from bore fluid acting on the pipe.

In many known flexible pipe designs the pipe body includes one or more tensile armour layers. The primary loading on such a layer is tension. In high pressure applications, such as in deep and ultra-deep water environments, the tensile armour layer experiences high tension loads from a combination of the internal pressure end cap load and the self-supported weight of the flexible pipe. This can cause failure in the flexible pipe since such conditions are experienced over prolonged periods of time.

One technique that has been attempted in the past to in some way alleviate the above-mentioned problems is the addition of rigid buoyancy elements at predetermined locations along the length of a vertical or catenary riser, which is suspended from a floating facility and extending to the seabed. A rigid buoyancy element is typically a cylindrical element with rigid walls and a central compartment that is gas filled to a high pressure. The buoyancy element has a buoyancy that is greater than the flexible pipe, such that the buoyancy element provides an uplift to help offset the weight of the pipe. The buoyancy element is clamped or attached to the pipe, generally surrounding the pipe around its circumference.

WO2007/125276 discloses such an arrangement. The rigid buoyancy elements provide an upwards lift to counteract the weight of the riser, effectively taking a portion of the weight of the riser, at various points along its length.

FIG. 2 illustrates a known riser assembly 200 in a configuration suitable for transporting production fluid such as oil and/or gas and/or water from a sub-sea location 201 to a floating facility 202. For example, in FIG. 2 the sub-sea location 201 is a sub-sea flow line 203. The flexible flow line 203 comprises a flexible pipe, wholly or in part, resting on the sea floor 204 or buried below the sea floor and used in a static application. The floating facility may be provided by a platform or, as illustrated in FIG. 2, a ship. Any such floating facility may be used, and as used herein the term “vessel” is used to encompass any floating facility. The riser 200 is provided as a flexible riser, that is to say a flexible pipe connecting the ship to the sea floor installation. Here, the flexible pipe includes five segments of flexible pipe body 205₀ to 205₄ and four junctions between adjacent segments of pipe body. At each junction, a buoyancy module 206₀ to 206₃ is attached in some way to the flexible pipe to give uplift to the pipe and reduce the tension loading along the pipe length. This configuration is sometimes known as a ‘stepped riser’ configuration.

FIG. 3 illustrates a buoyancy module 306 having a channel for receiving a flexible pipe 310.

WO2012/172305 discloses another riser assembly including a riser having a plurality of buoyancy elements at predetermined intervals along the riser for supporting the riser.

WO2013/079915 also discloses buoyancy compensating elements for connection to a flexible pipe. The buoyancy compensating elements may have connectors or flanges 312 for connecting buoyancy compensating elements together in an inline configuration.

FIG. 4 shows a number of buoyancy modules 306₁₋₄ attached to a flexible pipe, at a midline connection 314, in an inline configuration.

WO2016/102915 discloses another riser assembly including a riser having a plurality of rigid buoyancy elements in sections at predetermined intervals along the riser for supporting the riser.

Typically, rigid buoyancy modules are pre-pressurised and must be treated carefully, within operating guidelines, prior to being deployed. For deep water applications, rigid buoyancy modules are particularly heavy structures, as well as being pressurised and must be treated with a lot of care. However, after the pipe is deployed and in position (subsea), the buoyancy modules must be sturdy and physically capable of remaining in place for the lifetime of the flexible pipe's use, often around 25 years.

According to a first aspect of the present invention there is provided a buoyancy compensating assembly for connection to a portion of flexible pipe, comprising;
at least one rigid buoyancy module for connection to a riser; and
at least one regulating element configured to control the pressure within the at least one rigid buoyancy module in use.

According to a second aspect of the present invention there is provided a riser assembly for transporting fluids from a sub-sea location, comprising;
a riser comprising at least one segment of flexible pipe; and
the assembly of any preceding claim.

According to a third aspect of the present invention there is provided a method of deploying a riser assembly comprising at least one segment of flexible pipe from a vessel or floating workstation to a mid-water position, the method comprising:
providing at least one buoyancy compensating assembly comprising at least one rigid buoyancy module and at least one regulating element;
arranging the at least one buoyancy compensating assembly on a riser;
deploying the riser to a predetermined depth; and
controlling the pressure within the at least one rigid buoyancy module during deployment of the riser with the at least one regulating element.

Certain embodiments provide an assembly with a controllable or variable pressure state for enabling pressure to be relatively low prior to deployment, but at an appropriate, higher pressure when the pipe is positioned in its in-use location.

Certain embodiments provide the advantage that the rigid buoyancy modules can be prevented from collapse during both installation and service.

Certain embodiments provide the advantage that during the manufacture and handling of buoyancy modules prior to deployment, the buoyancy module can be taken as a non- or low-pressure vessel, thereby improving handle-ability of the buoyancy module.

### BRIEF DESCRIPTION OF THE DRAWINGS

Embodiments of the invention are further described hereinafter with reference to the accompanying drawings, in which:

FIG. 1 illustrates a flexible pipe body;

FIG. 2 illustrates a prior art stepped riser configuration;

FIG. 3 illustrates a buoyancy module on a flexible pipe;

FIG. 4 illustrates buoyancy modules in an inline configuration;

FIG. 5 illustrates a buoyancy compensating assembly;

FIGS. 6a and 6b illustrates the control valve of the buoyancy compensating assembly of FIG. 5;

FIG. 7 illustrates another buoyancy compensating assembly;

FIG. 8 illustrates the buoyancy compensating assembly of FIG. 7, where the conduit has been disconnected from the high pressure reservoir;

FIG. 9 illustrates another buoyancy compensating assembly including a plurality of rigid buoyancy modules;

FIG. 10 illustrates another buoyancy compensating assembly including a plurality of rigid buoyancy modules; and

FIGS. 11a and 11b illustrate another buoyancy compensating assembly including a diaphragm.

In the drawings like reference numerals refer to like parts.

### DETAILED DESCRIPTION

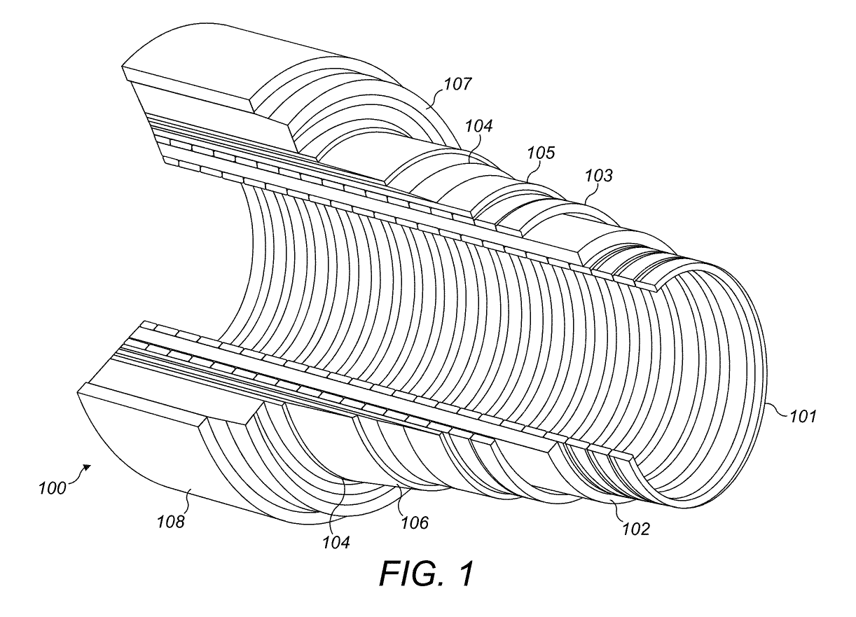

Throughout this description, reference will be made to a flexible pipe. It will be understood that a flexible pipe is an assembly of a portion of pipe body and one or more end fittings in each of which a respective end of the pipe body is terminated. FIG. 1 illustrates how pipe body 100 is formed in accordance with an embodiment from a combination of layered materials that form a pressure-containing conduit. Although a number of particular layers are illustrated in FIG. 1, it is to be understood that the pipe body is broadly applicable to coaxial structures including two or more layers manufactured from a variety of possible materials. For example, the pipe body may be formed from polymer layers, metallic layers, composite layers, or a combination of different materials. It is to be further noted that the layer thicknesses are shown for illustrative purposes only. As used herein, the term “composite” is used to broadly refer to a material that is formed from two or more different materials, for example a material formed from a matrix material and reinforcement fibres.

As illustrated in FIG. 1, a pipe body includes an optional innermost carcass layer 101. The carcass provides an interlocked construction that can be used as the innermost layer to prevent, totally or partially, collapse of an internal pressure sheath 102 due to pipe decompression, external pressure, and tensile armour pressure and mechanical crushing loads. The carcass layer is often a metallic layer, formed from stainless steel, for example. The carcass layer could also be formed from composite, polymer, or other material, or a combination of materials. It will be appreciated that embodiments are applicable to ‘smooth bore’ operations (i.e. without a carcass layer) as well as such ‘rough bore’ applications (with a carcass layer).

The internal pressure sheath 102 acts as a fluid retaining layer and comprises a polymer layer that ensures internal fluid integrity. It is to be understood that this layer may itself comprise a number of sub-layers. It will be appreciated that when the optional carcass layer is utilised the internal pressure sheath is often referred to by those skilled in the art as a barrier layer. In operation without such a carcass (so-called smooth bore operation) the internal pressure sheath may be referred to as a liner.

An optional pressure armour layer 103 is a structural layer that increases the resistance of the flexible pipe to internal and external pressure and mechanical crushing loads. The layer also structurally supports the internal pressure sheath, and typically may be formed from an interlocked construction of wires wound with a lay angle close to 90°. The pressure armour layer is often a metallic layer, formed from carbon steel, for example. The pressure armour layer could also be formed from composite, polymer, or other material, or a combination of materials.

The flexible pipe body also includes an optional first tensile armour layer 105 and optional second tensile armour layer 106. Each tensile armour layer is used to sustain tensile loads and internal pressure. The tensile armour layer is often formed from a plurality of wires (to impart strength to the layer) that are located over an inner layer and are helically wound along the length of the pipe at a lay angle typically between about 10° to 55°. The tensile armour layers are often counter-wound in pairs. The tensile armour layers are often metallic layers, formed from carbon steel, for example. The tensile armour layers could also be formed from composite, polymer, or other material, or a combination of materials.

The flexible pipe body shown also includes optional layers of tape 104 which help contain underlying layers and to some extent prevent abrasion between adjacent layers. The tape layer may be a polymer or composite or a combination of materials.

The flexible pipe body also typically includes optional layers of insulation 107 and an outer sheath 108, which comprises a polymer layer used to protect the pipe against penetration of seawater and other external environments, corrosion, abrasion and mechanical damage.

Each flexible pipe comprises at least one portion, sometimes referred to as a segment or section of pipe body 100 together with an end fitting located at at least one end of the flexible pipe. An end fitting provides a mechanical device which forms the transition between the flexible pipe body and a connector. The different pipe layers as shown, for example, in FIG. 1 are terminated in the end fitting in such a way as to transfer the load between the flexible pipe and the connector.

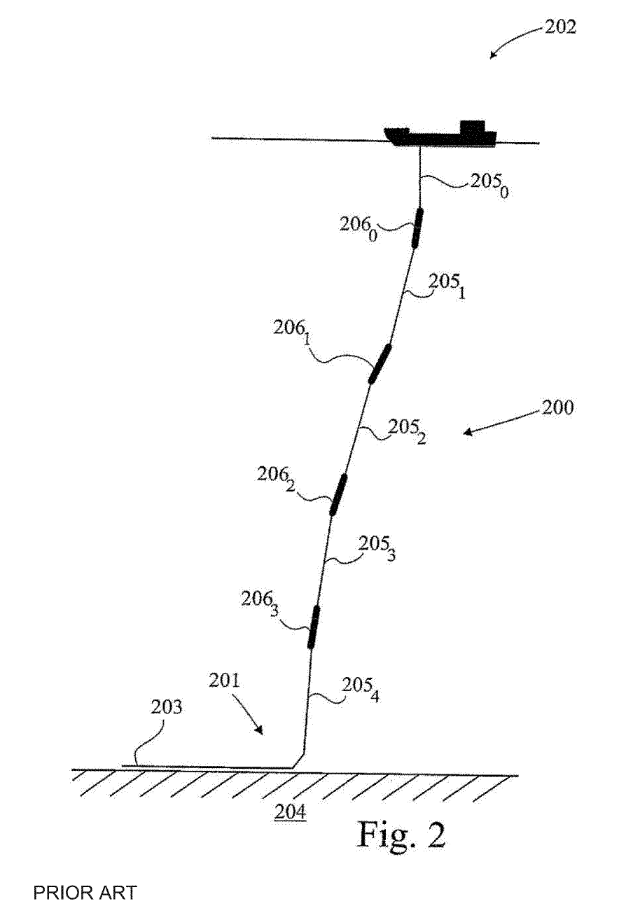

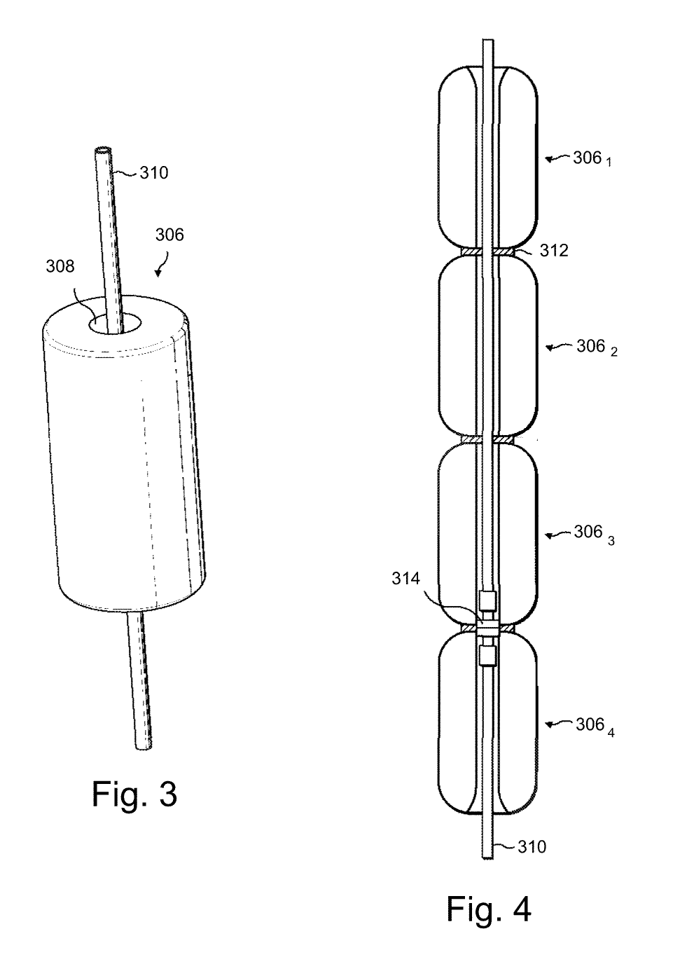

FIG. 2 illustrates a riser assembly suitable for transporting production fluid such as oil and/or gas and/or water from a sub-sea location to a floating facility.

It will be appreciated that there are different types of riser, as is well-known by those skilled in the art. Embodiments may be used with any type of riser, such as a freely suspended (free, catenary riser), a riser restrained to some extent (buoys, chains), totally restrained riser or enclosed in a tube (I or J tubes), where buoyancy modules can be attached.

The present invention relates to a rigid buoyancy compensating assembly for connection to a portion of flexible pipe.

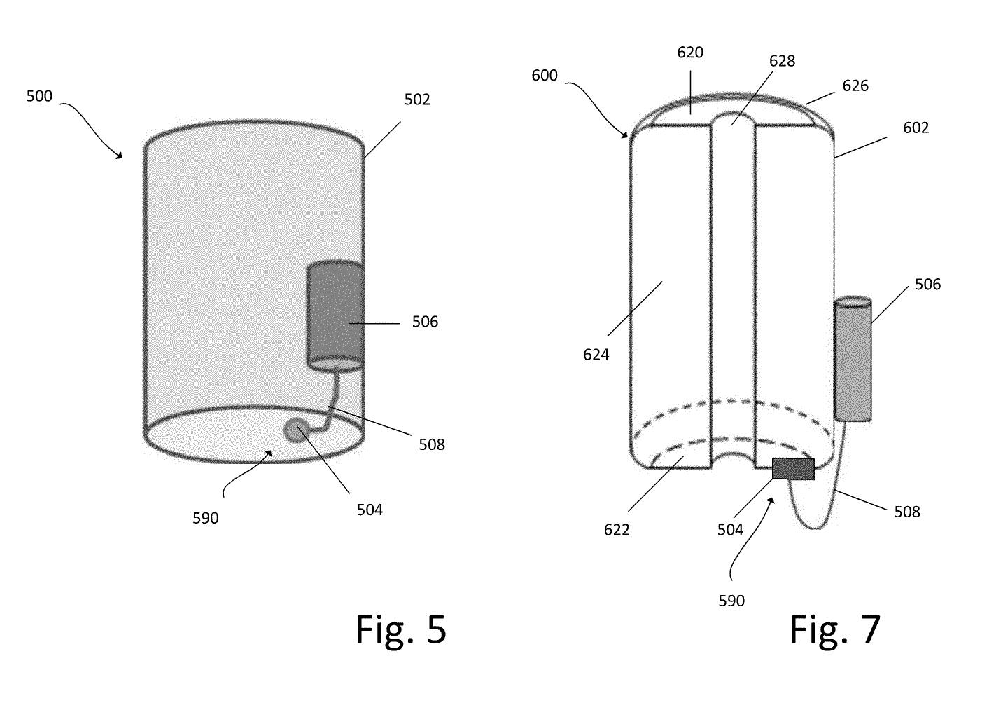

FIG. 5 illustrates a buoyancy compensating assembly 500 for connection to a portion of flexible pipe, including at least one rigid buoyancy module 502 for connection to a riser.

As used herein, the term “rigid”, with respect to a buoyancy module, encompasses a buoyancy module with stiffness and yield strength sufficient to prevent a substantial change in volume (for example, less than 5% change in volume) of the buoyancy module during typical initial operating conditions, where initial operating conditions may include pre-pressurisation of the buoyancy module prior to deployment and deployment of the buoyancy module to a shallow depth (such a depth may be determined by a structural engineer depending upon the design and materials of the buoyancy module, but would typically be less than 100 m; the design of the buoyancy module will be such that the external pressure from water at the initial operating depth will not be sufficient to damage or otherwise significantly change the volume by more than 5%). Aptly, a rigid buoyancy module is a buoyancy module comprising material having a Young's modulus greater than 100 GPa and/or a yield strength greater than 100 MPa.

In this example, the rigid buoyancy module 502 is a cylindrical tank with an interior space defined by the outer walls of the buoyancy module. The buoyancy module also has a central passage (not shown in FIG. 5), defined by an interior wall, that extends along the central axis of the module, to enable the module to be positioned on, and around, a flexible pipe. The buoyancy module 502 has walls made from stainless steel. The walls are around 0.5 inch (1.27 cm) in thickness. The buoyancy module may be 3-5 m in diameter and 3-5 m in height. The buoyancy module may provide 20-30 tonne of net buoyancy. This arrangement is suitable for use at a depth of between 100 m and 3000 m.

The buoyancy compensating assembly 500 further includes at least one regulating element 590 configured to control the pressure within the at least one rigid buoyancy module in use. As used herein, the term “in use” with respect to a buoyancy module, refers to the buoyancy module post deployment. That is, following deployment from a ship or vessel.

The buoyancy compensating assembly 500 includes a high pressure fluid source, associated with the at least one regulating element 590. In this example the high pressure fluid source is a high pressure reservoir 506. The at least one regulating element 590 is configured to control the pressure within the at least one rigid buoyancy module in use, using high pressure fluid from the high pressure fluid source.

In this example, the high pressure reservoir 506 is a canister made from stainless or alloy steel, or another suitable material, optionally coated with a corrosion inhibiting subsea coating system, as necessary depending on the material, in order to ensure the high pressure reservoir does not corrode detrimentally over time, the material also possessing sufficient strength to ensure the canister may contain fluid at very high pressure, sufficient to maintain the high pressure fluid as a liquid for example and therefore minimise the volume of the high pressure reservoir 506.

An example of such a canister which would be familiar to the reader, and could be suitable or adapted to be suitable, would be a CO₂ fire extinguisher cylinder.

In this example, the high pressure reservoir 506 contains pressurised CO₂ at a pressure between 0.1 and 6.0 MPa.

In this example, the rigid buoyancy module 502 comprises an inlet, for enabling the passage of a high pressure fluid from the high pressure reservoir 506 (i.e. the high pressure source) to the interior of the rigid buoyancy module.

In this example, the regulating element 590 includes control valve 504. The control valve 504 is coupled to the high pressure reservoir 506. The control valve 504 is for controlling the passage of the high pressure fluid from the high pressure fluid source to the interior of the rigid buoyancy module through the inlet.

That is, the control valve 504 is fluidly coupled to the rigid buoyancy module and fluidly coupled to the high pressure reservoir 506. As used herein, when the control valve 504 is “fluidly coupled” to the at least one rigid buoyancy module, it may be provided as part of the buoyancy module 502 (e.g. in a wall of the buoyancy module), or external to the buoyancy module 502 and coupled directly or indirectly in a manner such that fluid may pass from the high pressure reservoir 506 into the buoyancy module 502. In the FIG. 5 example the control valve 504 is provided in the wall of the buoyancy module 502.

The high pressure reservoir 506 is mounted on the rigid buoyancy module 502 with a strap (not shown).

The control valve 504 is located on the underside wall of the buoyancy module 502 and is fluidly coupled to the interior of the rigid buoyancy module 502. The control valve 504 is also fluidly coupled to the high pressure reservoir 506 by a conduit 508. The control valve controls the passage of fluid from the high pressure reservoir 506 to the interior of the rigid buoyancy module 502. The passage of fluid is through the conduit.

The pressure within an interior of the rigid buoyancy module is automatically adjustable. In this example, the pressure within the interior of the at least one rigid buoyancy module 502 is initially, automatically adjustable to fill the buoyancy module with fluid from the high pressure reservoir 506. The control valve 504 automatically adjusts the pressure within an interior of the at least one rigid buoyancy module 502 by controlling the passage of fluid (e.g. by allowing or preventing passage of fluid from the high pressure reservoir into the buoyancy module).

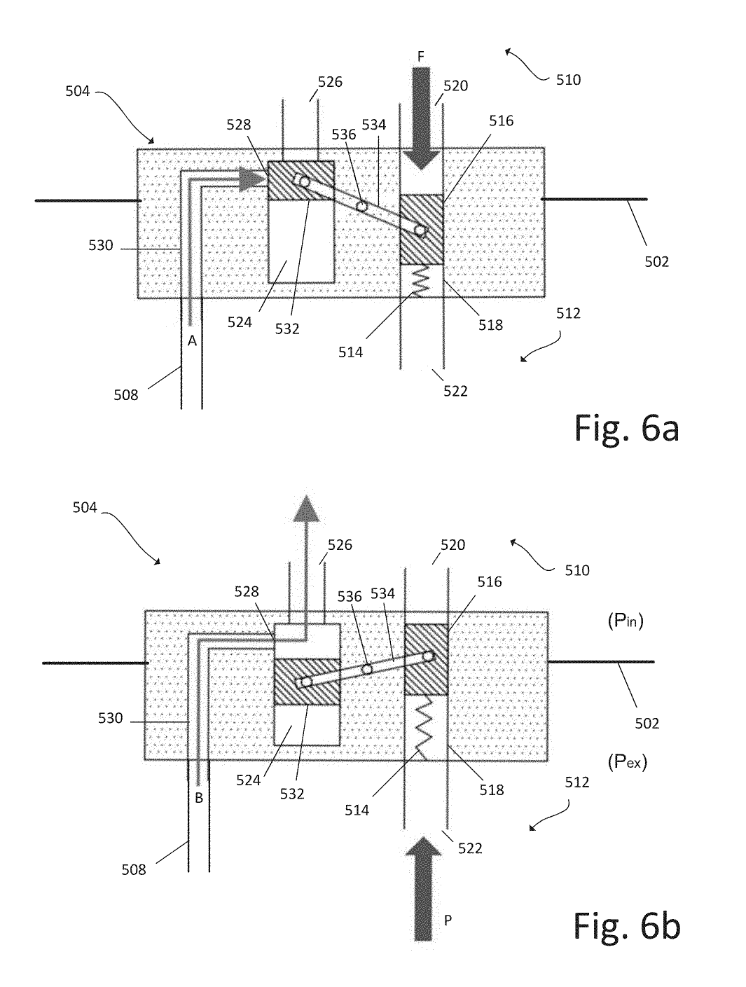

FIGS. 6A and 6B illustrate the control valve 504 of the regulating element 590 disposed on the rigid buoyancy module 502 for controlling the passage of fluid from the high pressure reservoir 506 (not shown in FIG. 6A and FIG. 6B) to the interior 510 of the rigid buoyancy module 502.

The regulating element further comprises a sensor arrangement. In this example the sensor arrangement is integral with the control valve 504. In this example, the sensor arrangement is a mechanical sensor arrangement.

The sensor arrangement includes a channel 518, with a first inlet 520 within the interior 510 of the rigid buoyancy module 502 and a second inlet 522 exterior to the rigid buoyancy module 502. The sensing arrangement also includes a member 516, housed and slidably engaged within the channel 518. The member 516 is retained within the channel 518 by a biasing element 514, which in this example is a spring.

The control valve 504 adjusts the pressure within the interior of the rigid buoyancy module according to a sensed condition by the sensor arrangement. In this example, the control valve 504 adjusts the pressure within the interior of the rigid buoyancy module according to the pressure differential between the interior 510 and exterior 512 of the at least one rigid buoyancy module. That is, the control valve 504 automatically balances the internal pressure of the rigid buoyancy module 510 and the external hydrostatic pressure. That is, until the internal pressure equals the external pressure.

In this example, the sensor arrangement further includes a chamber 524. The chamber 524 includes an inlet 526 within the interior 510 of the rigid buoyancy module 502. The chamber 524 further includes a further inlet 528, fluidly coupled via a channel 530 to the conduit 508. The sensor arrangement also includes a member 532, housed and slidably engaged with the walls of the chamber 524.

The members 516 and 532 are pivotally coupled via a connecting bar 534, which pivots around a pivot point 536.

FIG. 6A illustrates a situation where the pressure inside the interior 510, P_{IN}, of the rigid buoyancy module is greater than the pressure exterior 512 to the rigid buoyancy module, P_{EX}. In this situation, the difference in pressure results in a resultant force F (as shown by the arrow) acting on the member 516 of the sensor arrangement, such that it moves towards the inlet 522, compressing the biasing element 514.

As the member 516 is forced towards inlet 522, the connecting bar 534 is pivoted around the pivot point 536 such that the member 532 moves towards the end of the chamber 524 proximate to the inlet 526. In doing so, the member 532 covers the inlet 528. That is, when P_{IN} is greater than P_{EX} the member 532 covers the inlet 528, such that the high pressure reservoir 506 is not fluidly coupled with the chamber 524 (via the conduit 508). High pressure fluid from the high pressure reservoir is therefore prevented from entering the interior 510 of the rigid buoyancy module 502 (as shown by arrow A).

FIG. 6B illustrates a situation where P_{IN} is less than P_{EX}. In this situation, the difference in pressure results in a resultant force P (as shown by the arrow) acting on the member 516 of the sensor arrangement, such that it moves towards the inlet 520, extending the biasing element 514.

As the member 516 is forced towards the inlet 520, the connecting bar 534 is pivoted around the pivot point 536 such that member 532 moves away from the end of the chamber 524 proximate to inlet 526. In doing so, the member 532 no longer covers the inlet 528. That is, when P_{IN} is less than P_{EX} the member 532 does not cover the inlet 528, such that the high pressure reservoir 506 is fluidly coupled with the chamber 524 and also the interior 510 of the rigid buoyancy module. High pressure fluid from the high pressure reservoir can therefore enter the interior 510 of the rigid buoyancy module 502 (as shown by arrow B).

In this way, when a buoyancy module, attached to a flexible pipe, is lowered into position subsea, as the hydrostatic pressure increases, the regulating element (in this example including both the control valve 504 and the sensor arrangement) will enable high pressure fluid to transfer from the high pressure reservoir 506 to the interior of the buoyancy module.

In this example, the control valve 504 is a one-way valve. That is, the control valve prevents fluid in an interior of the buoyancy module from flowing to an exterior of the buoyancy module.

The bias of the biasing element 514 is such that once the internal and external pressures are balanced by the control valve, i.e. P_{IN} is equal to P_{EX}, the biasing element returns to a neutral position, such that the high pressure reservoir 506 is not fluidly coupled with the chamber 524. When the biasing element 514 is in its neutral position the inlet 528 remains covered by member 512, and hence the high pressure reservoir 506 is not fluidly coupled with the chamber 524. That is, the neutral position of the biasing element 514 positions the member 516 such that the connecting bar 534 positions the member 532 over inlet 528.

In this way, fluid is only transferred to the high pressure reservoir when the sensor arrangement detects that the external pressure is greater than the internal pressure.

FIG. 7 illustrates another example of a buoyancy compensating assembly 600. In this example the buoyancy compensating assembly 600 include a split rigid buoyancy module element 602. That is the buoyancy module is formed of two halves, i.e. two body portions (only one of which is shown in FIG. 7) that couple around the riser.

As shown by the buoyancy module 602, each half of the split rigid buoyancy module is generally semi-cylindrical, having a first generally semi-circular end surface 620, a second generally semi-circular end surface 622 opposed to the first end surface, a generally flat face 624 extending between the first and second end surfaces, and a curved surface 626 extending between the first and second end surfaces.

The generally flat face 624 is interrupted by a cutaway portion 628 that extends between the first and second end surfaces 620,622. The cutaway portion 628 is itself semi-cylindrical.

The two body portions of buoyancy module 602 are configured to be connectable to each other. In this example the two body portions are connected via a hinge. The body portions may also be joined by bolts to secure the portions to each other. The bolts may be inserted into appropriately sized hollowed cavities in the body portions and tightened. Alternatively, it will be appreciated that many other forms of configuration could be used to connect the body portions, such as straps or other windings around the joined portions, or forms of adhesive or weldment, for example. Recesses and matching projections in the surface 624 (not shown for simplicity) may be applied to help locate the two halves of the buoyancy compensating assembly.

The cutaway portion 628 of each body portion is configured (sized and shaped) such that when the body portions are connected, the body portions will envelop a flexible pipe. Since the cutaway portions are semi-cylindrical, they will form a cylindrical channel to receive a flexible pipe.

In use, the buoyancy compensating assembly is attached to a flexible pipe for transporting fluids from a sub-sea location.

In this example the rigid buoyancy module 502 attaches directly to the riser. That is, the riser passes through the central passage (not shown in FIG. 5) running longitudinally through the rigid buoyancy module 502 (or the channel formed by the mating cutaway portions 628 as per the example of FIG. 6). Alternatively, the riser may comprise a recess sized and shaped to receive a clamp which attaches directly to the flexible pipe body, or even receive an end fitting of the flexible pipe, and so locate and secure the buoyancy compensating assembly at a location on the pipe.

The flexible pipe may be deployed from a vessel or floating workstation to a mid-water position. The method of deployment includes arranging the at least one buoyancy compensating assembly on a riser, deploying the riser to a predetermined depth, and controlling the pressure within the at least one rigid buoyancy module during deployment of the riser with the at least one regulating element.

Initially, in a first state prior to deployment, the buoyancy module has fluid inside that is at an ambient pressure (e.g. 1 atm).

As the riser is deployed and the buoyancy module goes deeper underwater, the hydrostatic pressure to which the rigid buoyancy module 502 is subject to, increases as a result of the increasing depth. That is, P_{EX} increases with increasing depth. The pressure within the interior of the at least one rigid buoyancy module is automatically adjusted as the riser is deployed. I.e. the control valve 504 and sensor arrangement operate in the manner described above to automatically increase the internal pressure of the at least one rigid buoyancy module as the external pressure increases when the riser is deployed.

In this example, the control valve 504 is configured to be decoupled from the high pressure reservoir at a predetermined depth or pressure level, or when the external pressure becomes stable. The decoupling may be activated automatically upon reaching the target. The predetermined depth may be any depth, for example the predetermined depth may be a mid-water position.

By decoupling the control valve from the high pressure reservoir, the control valve can no longer (and is no longer needed to) automatically adjust the pressure inside the interior of the rigid buoyancy module.

In this second state, the buoyancy module is ready for use in supporting the flexible pipe during its lifetime, where production fluids are transported through the subsea flexible pipe, e.g. to a surface vessel. Thus, the buoyancy module is positioned subsea, in a pressurised state and performs its function of providing upwards buoyancy to the flexible pipe in the same way as other known buoyancy module arrangements.

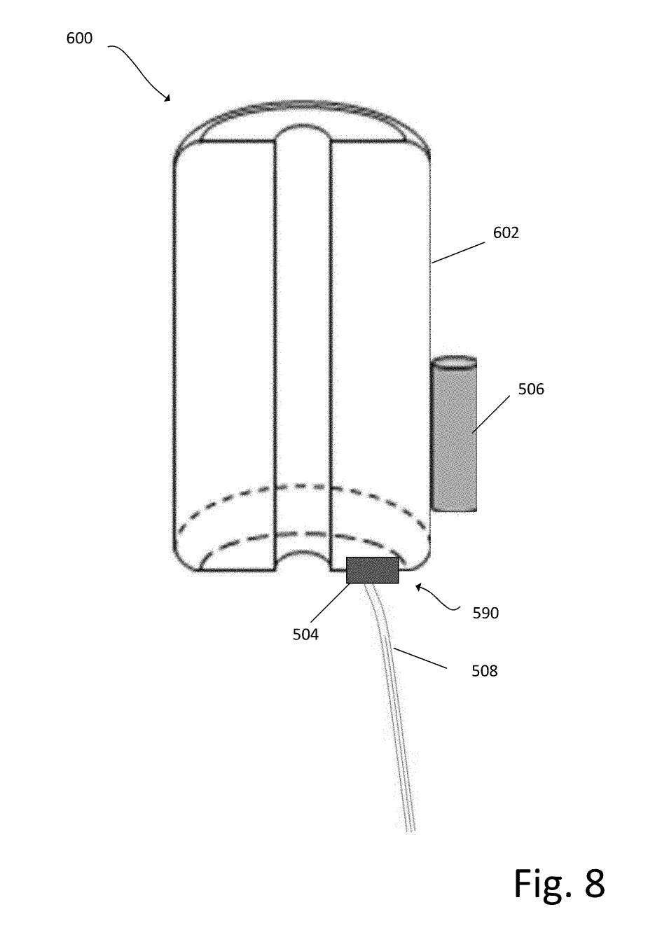

FIG. 8 illustrates the buoyancy compensating assembly 600 with the high pressure reservoir 506 decoupled from the control valve 504. In this example the control valve 504 is decoupled by disconnecting the conduit 508 from the high pressure reservoir.

Once the conduit is decoupled from the high pressure reservoir, water may enter the conduit to form a water seal, preventing any leakage of pressurised fluid from inside the rigid buoyancy module.

The buoyancy compensating assembly may include any number of rigid buoyancy modules with this arrangement. For example, there may be 1, 2, 3 or more rigid buoyancy modules.

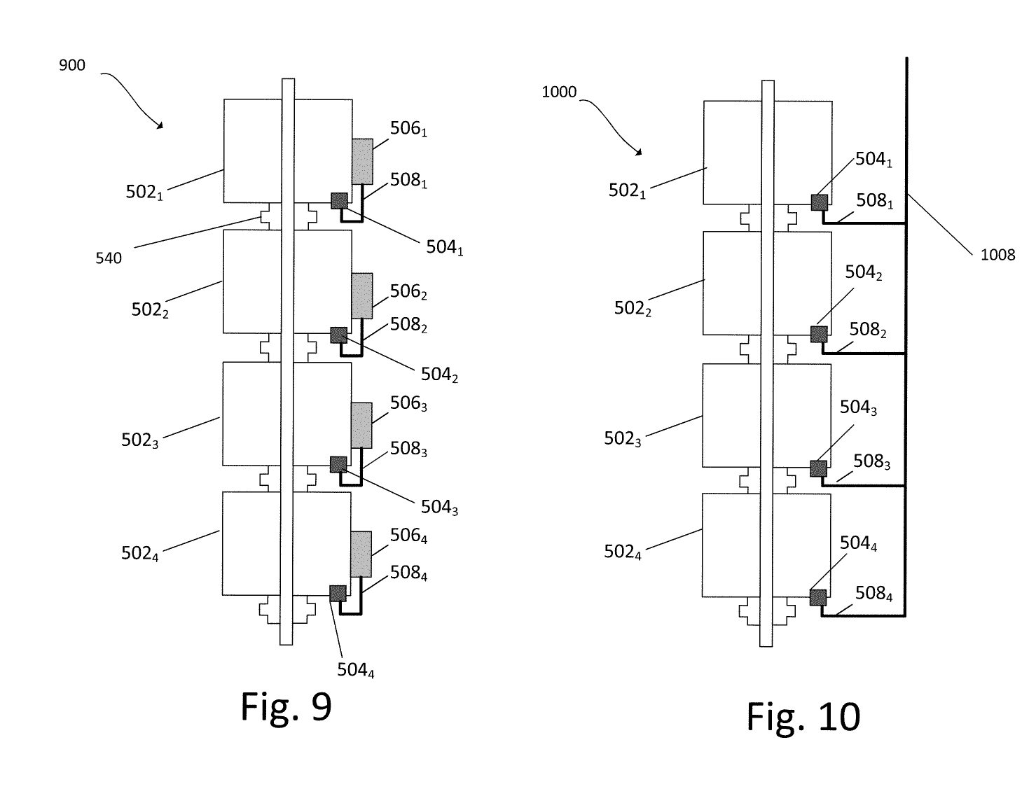

FIG. 9 illustrates a buoyancy compensating assembly 900 including four rigid buoyancy modules 502. The in-line connection of buoyancy modules is known per se, as described in WO2013/079915 A2 and incorporated herein by reference. In this example the rigid buoyancy modules are connected in-line by a connector 540.

In this example, in the same way as the example of FIG. 5, each high pressure reservoir 506₁₋₄ is mounted/attached to a corresponding buoyancy module 502₁₋₄ and fluidly coupled to said buoyancy module 502₁₋₄ via a corresponding control valve 504₁₋₄ and a conduit 508₁₋₄. That is, each rigid buoyancy module 502₁₋₄, includes a regulating element, including a control valve and a sensor arrangement, wherein each regulating element is configured to control the pressure within the corresponding rigid buoyancy module in use.

That is, the pressure within the interior of each of the rigid buoyancy modules is automatically adjustable, as per the previous examples. Each rigid buoyancy module is independently adjustable by a respective control valve. The predetermined depth will likely be different for each rigid buoyancy module. The pressures experience by each buoyancy module will likely be different, and the control valve associated with each rigid buoyancy module may decouple from the corresponding high pressure reservoir at different times.

FIG. 10 illustrates a further example of a buoyancy compensating assembly 1000. This example is similar to the example of FIG. 9, except that each rigid buoyancy module 502₁₋₄ does not have a respective high pressure reservoir mounted thereon. In this example, the conduits 508₁₋₄ corresponding to each control valve join a main conduit 1008, which is fluidly coupled to a single high pressure reservoir (not shown), which may be located on the deck of the vessel or floating workstation.

The differing depths of the buoyancy module results in different pressure requirements. That is, as the depth of the buoyancy module increases by say 100 m the external hydrostatic pressure increases by approximately 1 MPa. Therefore, each control valve moderates the fluid intake from the common reservoir accordingly. For example, for a buoyancy module deployed to 1000 m, the internal pressure may be required to be 10 MPa to equate substantially to the external pressure. Deployment of a series of buoyancy modules may require differently set control valves depending on their respective water depths in order to ensure adequate and suitable supply of pressurised fluid pressure to each module at each of their respective depths. Alternatively, separate supplies could be adopted and controlled, supplied in parallel to the modules.

Various modifications to the detailed arrangements as described above are possible. For example, the high pressure fluid source may be located within the rigid buoyancy module itself. In such an example, the regulating element will be coupled to the high pressure fluid source to control the pressure within the rigid buoyancy module in use by releasing high fluid directly into the interior of the rigid buoyancy module.

The high pressure fluid source may be an inflator arrangement. The inflator arrangement may be any arrangement suitable for generating a high pressure fluid. For example, the inflator arrangement may be an ‘air-bag’ type mechanism, which generates high pressure fluid through chemical reaction of one or more reactants.

For example, the inflator arrangement may include a supply of a reactant. Upon, application of temperature (via a suitably positioned heating element) to the reactant, the reactant may decompose to produce a volume of fluid. For example, the reactant may decompose into a product and a volume of fluid. The reactant may be sodium azide, for example, which decomposes upon application of heat to sodium and nitrogen gas, although any suitable reactant may be used. Undesired reactions products (e.g. sodium in this case) may be further reacted with additional reactants to produce a stable reaction product. Alternatively, the inflator arrangement may include supplies of at least two reactants (for instance isocyanate and polyol resin), which upon mixing thereof produce an expanded volume of fluid. As with the example above, one or both of the reactants may first be deployed into a separate reaction chamber/interior of the buoyancy module. The reaction may be aided with the application of temperature via a suitably positioned heating element.

The reactant (or reactants) may be heated in situ (i.e. within the reactant supply). Alternatively, the reactant may first be deployed into a separate reaction chamber and then heated. Alternatively, the reactant may first be deployed into the interior of the buoyancy module and then heated.

The volume of fluid produced may be that required to balance the internal and external pressure of the rigid buoyancy module. For example, the volume of fluid produced may be determined according a sensed condition by the sensing arrangement. Alternatively, the volume of fluid produced may be unrelated to the required volume of fluid for balancing the internal and external pressure of the rigid buoyancy module and a control valve may instead be used to regulate the required flow of fluid to the interior of the buoyancy module to balance internal and external pressure of the buoyancy module.

The inflator arrangement may be coupled to and/or mounted on and/or decoupled from the rigid buoyancy module in the manner described for high pressure reservoir 506.

The inflator arrangement may be single-use. That is, substantially the entirety of the reactant may be used in a single reaction.

The high pressure fluid source may include both a high pressure reservoir and an inflator arrangement. That is, the inflator arrangement may be used to provide a high pressure reservoir with high pressure fluid. For instance, in the detailed examples described above, a separate inflator arrangement may be used to re-pressurise the high reservoir during use.

The high pressure fluid source may be releasably mounted on the rigid buoyancy module. Alternatively, the high pressure fluid source may be replaced following deployment of the rigid buoyancy element. For example, the high pressure fluid source may be replaced to re-pressurise the buoyancy module, the internal pressure of which may have decreased over time. The high pressure fluid source may be replaced by a diver or an ROV (Remotely Operated Vehicle), for example.

The high pressure fluid source may include a further control valve, for decoupling the high pressure fluid source from any other component. For example, the further control valve may be used to decouple the high pressure fluid source from the regulating element prior to disconnection. That is, the further control valve may couple the interior of the high pressure fluid source to the conduit.

The high pressure source may include any suitable pressurised fluid, for example liquefied CO₂, butane, propane, or nitrous oxide. These fluids are advantageous as they can be liquefied purely by pressure at room temperature. Other fluids (including air) may be compressed and act under that compression as super-critical fluids, but may not have turned from gas to liquid during pressurization.

The high pressure fluid may be an expandable foam (for instance isocyanate and polyol resin). This would provide the advantage that the foam increases the pressure within an interior of the buoyancy module but may also adhere to and solidify to repair/seal any cracks in the buoyancy module.

The high pressure source may be mounted to the rigid buoyancy module in any suitable way, for example the high pressure reservoir may be clamped or welded, bolted or such-like directly to the module or indirectly via a hanging bracket.

The regulating element may include separate a control valve and sensor arrangement. I.e. the sensor arrangement may not be integrated within the control valve. For example, the sensor arrangement may include one or more sensor elements coupled to the rigid buoyancy module.

The regulating element may include a control valve and/or a sensor arrangement. That is, there may be no control valve or sensor arrangement. For example, the regulating element may include a sensor arrangement only, which triggers an inflator arrangement to produce a volume of fluid. That is, there may be no need for a control valve to regulate the flow of from the inflator arrangement and the buoyancy module.

The control valve may be manually actuated, either remotely or by a diver or ROV. That is, actuation of the control valve may not be done in response to a sensed condition by the sensor arrangement.

Any suitable sensor arrangement may be used. For example, the sensor arrangement may include at least two pressure sensors, at least one within an interior of the rigid buoyancy module and at least one on an exterior of the rigid buoyancy module. The sensors may be mechanical sensors, electric sensors or electro-mechanical sensors.

The sensor arrangement and the control valve may interact in any suitable manner. For example, the control valve may actuate to fluidly connect the interior of the rigid buoyancy module and the high pressure reservoir when the difference between the interior and exterior pressure sensor readings are above a threshold level. Alternatively/in addition, the control valve may actuate if the external pressure is above a threshold level, for example >5 bar.

It is useful to arrange the control valve to set the pressure inside the buoyancy module to be, e.g. 1 bar higher than the pressure external to the buoyancy module. This allows a factor of safety in preventing collapse of the buoyancy module due to external pressure, if the buoyancy module from its deployed depth, for example due to the increased weight of the flexible pipe due to marine growth. To achieve this pressure differential, during deployment the control valve will allow the passage of fluid from the high pressure reservoir to the interior of the buoyancy module when the internal pressure is less than the desired pressure (e.g. 1 bar greater than the external pressure). That is, the biasing element of the examples above will be in its ‘neutral position’ when the internal pressure is equal to the desired pressure (e.g. 1 bar greater than the external pressure).

The control valve and/or the sensor arrangement may be an integral part of the buoyancy module, for example formed as part of a wall of the buoyancy module.

The control valve may be decoupled by sealing the conduit and/or the control valve.

The control valve 504 may be decoupled by sealing the conduit 508 and/or the control valve 504. This may be required for system maintenance for instance, or de-commissioning, and may comprise manually or ROV operated ball valves of a suitable size and pressure.

The control valve may be decoupled from the buoyancy module when the internal and external pressure reach a target level. The control module may be decoupled remotely, or manually either by a diver or a ROV

Any suitable conduit may be used to fluidly couple the control valve to the high pressure reservoir however preferably the conduit would comprise a steel or alloy or composite material, of a single wall or multi-layer construction suitable for the external seawater environment and for containing the required pressure.

The buoyancy compensating assembly 500 may be attached to the riser in any suitable manner, for example the rigid buoyancy module 502 of the buoyancy compensating assembly may be clamped to a rigid connector of the riser.

The rigid buoyancy module may include a bladder or diaphragm located within an interior thereof. The bladder element may comprise an elastomeric balloon or polymer liner, or a bellows arrangement within the structure of the rigid buoyancy module.

The buoyancy module may be of any suitable shape with an interior and may be constructed using any suitable structural material for walls. For example the walls may be of metal or composite material or polymer material, e.g. polyurethane, and may be comprised of solid walls, or an open or semi-open lattice work of structural reinforcement.

When used in combination with a bladder or polymer liner, the rigid buoyancy module itself may include a lattice structure, which protects the bladder element located within an interior thereof. With a bellows arrangement within the rigid buoyancy module the bellows may itself be structurally capable of containing the internal pressure and the rigid buoyancy module outside it protects the bellows arrangement from damage.

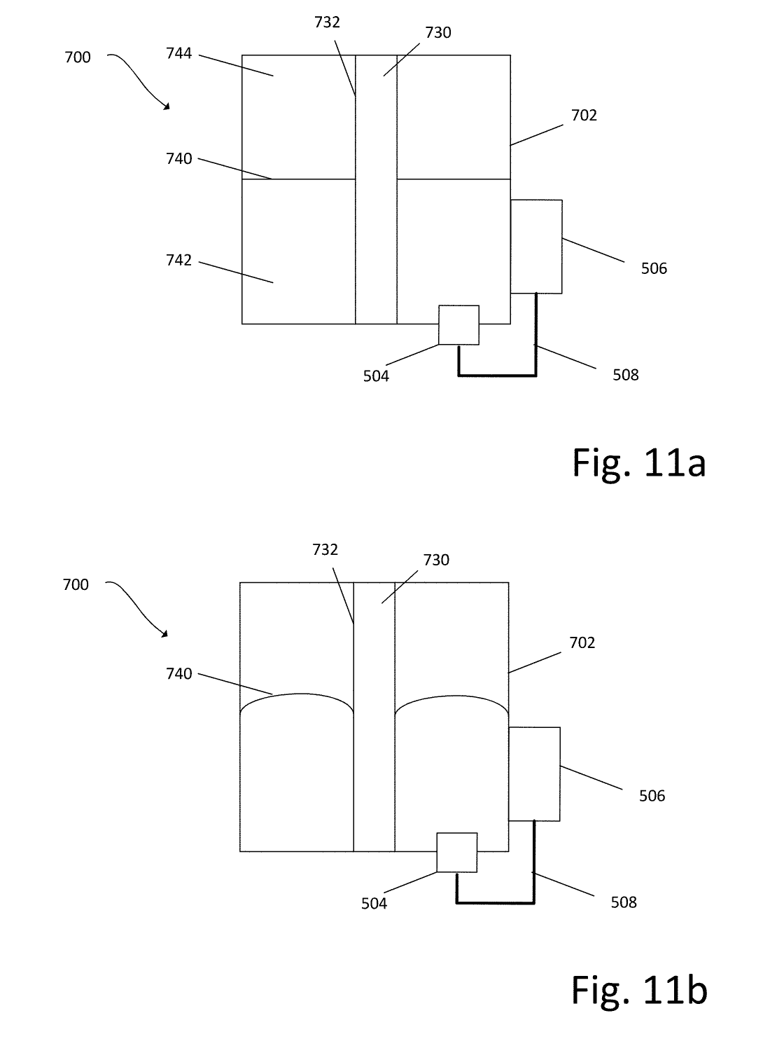

A diaphragm may be used where only a portion (for instance half) of the interior of the rigid buoyancy module acts to contain the pressure. FIG. 11a illustrates a vertical cross-section through a buoyancy compensating assembly 700, including a rigid buoyancy module 702 and a central passage 730 defined by an interior wall 732 to enable the module to be positioned on, and around, a flexible pipe. As with previous embodiments, the buoyancy compensating assembly 700 includes a control valve 504, a high pressure reservoir 506 and a conduit 508.

In this example, the buoyancy compensating assembly 700 further includes a diaphragm 740. An outer perimeter of the diaphragm 740 is connected to an inner surface of the rigid buoyancy module. An inner perimeter of the diaphragm 740 is connected to an outer surface of the interior wall 732. The connection between the diaphragm 740 and the inner surface of the rigid buoyancy module and the outer surface of the interior wall 732 are sealed connections such that the interior of buoyancy module 702 is segregated into first and second compartments 742, 744 by the diaphragm, which are fluidly isolated from each other.

Upon the introduction of pressurised fluid into the buoyancy module 702 (in the same manner described in previous embodiments), the first compartment 742 (defined by the walls of the buoyancy module and the diaphragm) acts to contain the pressure.

The diaphragm 740 may advantageously be selected from an expandable material, for instance an elastomeric material, such that the diaphragm is able to expand into the second compartment 744 to form a concave pressure containing end within the first compartment 742, as shown in FIG. 11b.

The second compartment 744 of the rigid buoyancy module may include a valve to reduce the pressure within the second compartment 744, which will allow further expansion of the diaphragm into the second compartment 744 upon the further addition of pressurised fluid into the first compartment 742.

The walls of the buoyancy module, which provide the boundary for the second compartment 744 may alternatively comprise an open lattice framework, such that the interior of the second compartment 744 is fluidly linked with the external environment (and hence is at external hydrostatic pressure). In this manner, the lattice framework both provides protection to, and limits the expansion of, the diaphragm 740, without the second compartment 744 of the rigid buoyancy module structure being pressurised itself (relative to the external hydrostatic pressure).

The buoyancy module may be arranged on the riser in any suitable manner.

The buoyancy module may include one or more connectors or flanges for connecting the buoyancy module to further components.

The rigid buoyancy module and/or the bladder and/or the regulating element may include an overflow valve, to prevent the interior of the rigid buoyancy module and/or bladder becoming over-pressurised.

The at least one rigid buoyancy module may be partially pressurised prior to deployment.

With the above-described arrangements, a system is provided which, in a first state (prior to deployment) has rigid buoyancy modules that are at relatively low pressure and can be handled with ease at the surface compared to known arrangements. In a second state (in use, subsea), the buoyancy module exhibits a standard high pressure capability, so that upwards buoyancy is provided. The buoyancy module can remain in place and operational for the lifetime of the use of the flexible pipe, being provided its subsea location for around 25 years or more.

So, the buoyancy module is pressurised as it descends to its in-use location, is sealed (actively or passively), and then behaves as a known buoyancy module does for its use in supporting the flexible pipe.

A safe to use, non-reversible system is provided.

Certain embodiments provide the advantage that buoyancy modules of lower grade materials may be used in the assembly in comparison to those used in known systems.

Certain embodiments provide the advantage that buoyancy modules of smaller thickness may be used for the buoyancy module in comparison to those used in known systems.

It will be clear to a person skilled in the art that features described in relation to any of the embodiments described above can be applicable interchangeably between the different embodiments. The embodiments described above are examples to illustrate various features of the invention.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A buoyancy compensating assembly for connection to a portion of flexible pipe, comprising;
at least one rigid buoyancy module for connection to a riser; and
at least one regulating element configured to control a pressure within the at least one rigid buoyancy module in use, using high pressure fluid from a high pressure fluid source,
wherein the high pressure fluid source is associated with, and mounted on, the at least one regulating element, and
wherein the high pressure fluid source comprises at least one of a high pressure reservoir and an inflator arrangement.

2. (canceled)

3. The assembly as claimed in claim 1, wherein the at least one rigid buoyancy module comprises an inlet, for enabling passage of the high pressure fluid from the high pressure fluid source to an interior of the at least one rigid buoyancy module.

4. The assembly as claimed in claim 1, wherein the pressure within an interior of the at least one rigid buoyancy module is automatically adjustable.

5. The assembly as claimed in 3 wherein the at least one regulating element comprises a control valve coupled to the high pressure fluid source, for controlling passage of the high pressure fluid from the high pressure fluid source to the interior of the at least one rigid buoyancy module through the inlet.

6. The assembly as claimed in claim 1 wherein the at least one regulating element comprises a sensor arrangement.

7. The assembly as claimed in claim 6, wherein the at least one regulating element adjusts the pressure within an interior of the at least one rigid buoyancy module according to a sensed condition by the sensor arrangement.

8. The assembly as claimed in claim 7, wherein the at least one regulating element adjusts the pressure within the interior of the at least one rigid buoyancy module according to the pressure differential between the interior and exterior of the at least one rigid buoyancy module.

9. (canceled)

10. The An assembly as claimed in 1, wherein the inflator arrangement is configured to generate high pressure fluid through chemical reaction of one or more reactants.

11. The assembly as claimed in claim 5, wherein the control valve is configured to be decoupled from the high pressure fluid source at a predetermined depth.

12. The assembly as claimed in claim 5, wherein the control valve is fluidly coupled to the high pressure fluid source by a conduit.

13. The assembly as claimed in claim 12, wherein the control valve is decoupled by disconnecting the conduit from the high pressure source.

14. The assembly as claimed in claim 12, wherein the control valve is decoupled by sealing at least one of the conduit and the control valve.

15. The assembly as claimed in 5, wherein the control valve is a one-way valve.

16. (canceled)

17. The assembly as claimed in claim 1, wherein the assembly further comprises a bladder element within an interior of the at least one rigid buoyancy element.

18. The assembly as claimed in claim 1,
wherein the at least one rigid buoyancy module comprises a first and a further rigid buoyancy module,
wherein the at least one regulating element comprises at least two regulating elements, and
wherein at least one of the regulating elements is configured to control the pressure within the first rigid buoyancy module and other of the regulating elements is configured to control the pressure within the further rigid buoyancy module in use.

19. The assembly as claimed in 18, wherein the pressure within an interior of the further rigid buoyancy module is automatically adjustable.

20. The assembly as claimed in 18, wherein at least one of the regulating elements comprises at least one of a control valve and a sensor arrangement.

21. The assembly as claimed in claim 18, wherein the further rigid buoyancy module comprises an inlet, for enabling the passage of a high pressure fluid from a high pressure fluid source to an interior of the further rigid buoyancy module.

22. The assembly as claimed in claim 21, wherein the high pressure fluid source is a further high pressure source.

23. The assembly as claimed in claim 22, wherein the further high pressure reservoir is mounted on the further rigid buoyancy module.

24. The assembly as claimed in claim 1, wherein the at least one rigid buoyancy module is a split buoyancy module.

25. A riser assembly for transporting fluids from a sub-sea location, comprising;
a riser comprising at least one segment of flexible pipe; and
the assembly of claim 1.

26. A method of deploying a riser assembly comprising at least one segment of flexible pipe from a vessel or floating workstation to a mid-water position, the method comprising:
providing at least one buoyancy compensating assembly comprising at least one rigid buoyancy module and at least one regulating element;
arranging the at least one buoyancy compensating assembly on a riser;
deploying the riser to a predetermined depth; and
controlling a pressure within the at least one rigid buoyancy module during deployment of the riser with the at least one regulating element, using high pressure fluid from a high pressure fluid source,
wherein the high pressure fluid source is associated with, and mounted on, the at least one regulating element, and
wherein the high pressure fluid source comprises at least one of a high pressure reservoir and an inflator arrangement.

27. The method as claimed in claim 26, wherein controlling the pressure within the at least one rigid buoyancy module comprises:
controlling passage of the high pressure fluid from a high pressure fluid source to an interior of the at least one rigid buoyancy module.

28. The method as claimed in claim 27,
wherein the at least one regulating element comprises a control valve; and
wherein the control valve controls the passage of the high pressure fluid from the high pressure fluid source to the interior of the at least one rigid buoyancy module through an inlet of the at least one rigid buoyancy module.

29. The method as claimed in claim 26,
wherein the at least one regulating element comprises a sensor arrangement; and
wherein controlling the pressure within the at least one rigid buoyancy module further comprises adjusting the pressure within an interior of the at least one rigid buoyancy module according to a sensed condition by the sensor arrangement.

30. The method as claimed in claim 28, wherein the method further comprises decoupling the control valve from the high pressure fluid source once the riser reaches a predetermined depth.

31. The method as claimed in claim 26, wherein the method further comprises, partially pressurising the at least one buoyancy module prior to deployment.

32. The method as claimed in claim 26, wherein the method further comprises replacing the high pressure fluid source following deployment of the at least one rigid buoyancy element.
